(19) United States
(12) Patent Application Publication
(10) Pub. No.: US 2024/0217362 A1
(43) Pub. Date: Jul. 4, 2024

(54) WIRELESS CHARGING DEVICE, WIRELESS CHARGING METHOD, AND NON-TRANSITORY COMPUTER READABLE STORAGE MEDIUM

(71) Applicant: Panasonic Intellectual Property Corporation of America, Torrance, CA (US)

(72) Inventor: Nobuaki TASAKI, Osaka (JP)

(73) Assignee: Panasonic Intellectual Property Corporation of America, Torrance, CA (US)

(21) Appl. No.: 18/606,587

(22) Filed: Mar. 15, 2024

Related U.S. Application Data
(63) Continuation of application No. PCT/JP2022/035116, filed on Sep. 21, 2022.

(30) Foreign Application Priority Data
Sep. 24, 2021 (JP) 2021-155482

(51) Int. Cl. B60L 53/39; B60L 53/12; B60L 53/62

(52) U.S. Cl. CPC B60L 53/39; B60L 53/12; B60L 53/62; B60L 2200/12; B60L 2250/20; B60L 2250/22

(57) ABSTRACT

A wireless charging device includes: a power transmitter that wirelessly transmits power to a power receiver included in an electric moving body; a moving mechanism that moves the power transmitter, a detection unit that detects a stop position of the moving body; an acquisition unit that acquires information indicating a type of the moving body; an identification unit that identifies an attachment position of the power receiver based on the type; and a charge control unit that controls the moving mechanism based on the stop position and the attachment position to cause the power transmitter to approach the power receiver.

### FIELD OF INVENTION

The present disclosure relates to a technique for wirelessly charging an electric moving body.

### BACKGROUND ART

In recent years, an increasing number of service providers provide a service for sharing electric moving bodies such as an electric bicycle, an electric motorcycle, and an electric kick scooter. In accordance with the above, a charging device that can be shared by various moving bodies provided by service providers has been studied.

For example, Patent Literature 1 describes storing a type of an electric vehicle and control information for controlling charging of a storage battery included in the electric vehicle. Then, it is described that a type of an electric vehicle is determined based on vehicle type information obtained from the electric vehicle, and charging of a storage battery included in the electric vehicle is controlled based on control information corresponding to the type.

Patent Literature 2 describes that in a case where a vehicle is stopped on a power supply unit movable along the ground, the power supply unit is moved below a charging device provided at a bottom portion of the vehicle, and power is supplied to the charging device in a non-contact state.

However, there are many types of moving bodies provided by service providers, and it is difficult to unify attachment positions of power receivers that receive charging power. In the techniques of Patent Literature 1 and Patent Literature 2, it is not considered that power receivers may be attached to various positions such as a side surface of a vehicle without being limited to a bottom portion of a vehicle according to a vehicle type. For this reason, there is a possibility that a power transmitter that transmits power for charging in a non-contact manner cannot be brought close to a power receiver, and power cannot be transmitted to the power receiver.
Patent Literature 1: JP 6821107 B1
Patent Literature 2: JP 2014-144671 A

### SUMMARY OF THE INVENTION

The present disclosure has been made to solve the above problem, and an object of the present disclosure is to present a wireless charging device, a wireless charging method, and a non-transitory computer readable storage medium capable of appropriately bringing a power transmitter close to a power receiver according to a type of an electric moving body and appropriately transmitting power to the power receiver in a non-contact manner.

A wireless charging device according to one aspect of the present disclosure includes a power transmitter that wirelessly transmits power to a power receiver included in an electric moving body, a moving mechanism that moves the power transmitter, a detection unit that detects a stop position of the moving body, an acquisition unit that acquires information indicating a type of the moving body, an identification unit that identifies an attachment position of the power receiver based on the type, and a charge control unit that controls the moving mechanism based on the stop position and the attachment position to bring the power transmitter close to the power receiver.

### BRIEF DESCRIPTION OF THE DRAWINGS

FIG. 1 is a diagram illustrating an example of an overall configuration of a wireless charging system.

FIG. 2 is a diagram illustrating an example of a configuration of a server device.

FIG. 3 is a diagram illustrating an example of a method of detecting a position of a vehicle.

FIG. 4 is a perspective view illustrating an example of a power transmitter and a moving mechanism.

FIG. 5 is a flowchart illustrating an example of wireless charging processing.

FIG. 6 is a diagram illustrating another example of a method of detecting a stop position of a vehicle.

### DETAILED DESCRIPTION

### (Background of Present Disclosure)

As described above, in recent years, an increasing number of service providers provide a service for sharing electric moving bodies such as an electric bicycle, an electric motorcycle, and an electric kick scooter. In accordance with the above, a charging device that can be shared by various moving bodies provided by service providers has been studied.

However, there are many types of moving bodies provided by service providers, and it is difficult to unify attachment positions of power receivers that receive charging power. For example, in a case of small electric vehicles such as an electric kick scooter, an electric bicycle, and an electric motorcycle, a space for attaching a power receiver is limited. Specifically, in a case of an electric kick scooter, an attachment position of a power receiver is limited to a bottom plate (deck) on which a foot is placed, a handlebar, a frame that supports a handlebar, and the like. In a case of an electric bicycle and an electric motorcycle, an attachment position of a power receiver is limited to a handlebar, a frame that supports a handlebar, a frame that supports a saddle, and the like.

In the techniques of Patent Literature 1 and Patent Literature 2, since it is not considered that a power receiver may be attached to various positions depending on a vehicle type, there is a possibility that a power transmitter cannot be brought close to the power receiver. In this case, there is a possibility that power cannot be transmitted to the power receiver.

In view of the above, the present inventor has intensively studied a technique of appropriately bringing a power transmitter close to a power receiver according to a type of an electric moving body and appropriately transmitting power to the power receiver in a non-contact manner, and has arrived at each aspect of the present disclosure described below.

(1) A wireless charging device according to one aspect of the present disclosure includes a power transmitter that wirelessly transmits power to a power receiver included in an electric moving body, a moving mechanism that moves the power transmitter, a detection unit that detects a stop position of the moving body, an acquisition unit that acquires information indicating a type of the moving body, an identification unit that identifies an attachment position of the power receiver based on the type, and a charge control unit that controls the moving mechanism based on the stop position and the attachment position to bring the power transmitter close to the power receiver.

According to this configuration, a stop position of a moving body is detected, and further, an attachment position of the power receiver is identified based on a type of the moving body. For this reason, it is possible to appropriately grasp a position where the power receiver included in a moving body being stopped is present according to a type of the moving body. Further, in this configuration, not only the power transmitter can be simply moved by the moving mechanism, but also the power transmitter can be brought close to a position where the power receiver is present. As a result, the power transmitter approaching the power receiver can appropriately transmit power to the power receiver in a non-contact manner.

(2) In the wireless charging device according to (1), the identification unit may acquire power receiving position information in which the type is associated with a relative position of the power receiver when a predetermined portion of the moving body of the type is used as a reference, and identify the relative position associated with the type in the power receiving position information as the attachment position.

According to this configuration, it is possible to identify a relative position of the power receiver when a predetermined portion of a moving body according to a type of the moving body is used as a reference by using power receiving position information.

(3) In the wireless charging device according to (2), the charge control unit may set the stop position as a position of the predetermined portion of the moving body being stopped, and move the power transmitter to a position separated by a predetermined distance from the relative position indicated by the attachment position when the stop position is used as a reference.

According to this configuration, the power transmitter is moved to a position separated by a predetermined distance from a relative position indicated by the identified attachment position of the power receiver when a stop position of a moving body detected by the detection unit is used as a reference. For this reason, the power transmitter can be appropriately brought close to the power receiver.

(4) The wireless charging device according to (3) may further include a sensor that transmits a beacon signal and detects a direction from a position where the beacon signal is transmitted to a position where the beacon signal is received, the wireless charging device being installed side by side with other one or more wireless charging devices having a same configuration as that of the wireless charging device, in which the moving body may include a receiving circuit that receives the beacon signal, and the detection unit may detect the stop position based on the direction detected by the sensor and by the sensor included in one of the other one or more wireless charging devices.

According to this configuration, based on directions detected by two of the sensors included in each of two of the wireless charging devices having the same configuration installed side by side, it is possible to detect a position where the receiving circuit of the moving body being stopped that receives a beacon signal is present as a stop position of the moving body.

(5) The wireless charging device according to (3) may further include a distance measuring sensor that detects a distance to an object present in a predetermined stop area, in which the detection unit may detect the stop position based on the distance detected by the distance measuring sensor.

According to this configuration, in a case where the moving body is stopped in the predetermined stop area, a stop position of the moving body can be appropriately detected based on a distance detected by the distance measuring sensor included in the wireless charging device.

(6) In the wireless charging device, the moving mechanism may be configured to be capable of moving the power transmitter along a first direction parallel to the ground on which the moving mechanism is installed and a power transmission surface of power of the power transmitter, a second direction orthogonal to the ground, and a third direction orthogonal to the first direction and the second direction.

According to this configuration, by controlling the moving mechanism to three-dimensionally move the power transmitter along the first direction, the second direction, and the third direction, it is possible to bring the power transmitter close to the power receiver.

(7) In the wireless charging device according to (6), the moving mechanism may be further configured to be capable of rotating the power transmitter about a first axis parallel to the first direction and a second axis parallel to the second direction.

According to this configuration, by controlling the moving mechanism, it is possible to move the power transmitter three-dimensionally along the first direction, the second direction, and the third direction, and further, rotate the power transmitter about the first axis parallel to the first direction and the second axis parallel to the second direction, so as to appropriately bring the power transmitter close to the power receiver.

(8) The wireless charging device according to any one of (1) to (7) may further include a guide unit that determines whether or not the stop position is within a predetermined stop area, and guides the moving body to be stopped again within the stop area in a case where the stop position is outside the stop area.

According to this configuration, in a case where the stop position of the moving body is outside the predetermined stop area, it is possible to guide the moving body to be stopped again in the stop area. For this reason, it is possible to prevent the moving body from being stopped outside the stop area. As a result, a moving range of the power transmitter by the moving mechanism can be limited within the stop area, and the moving mechanism can be reduced in size.

(9) In the wireless charging device according to any one of (1) to (8), the charge control unit may determine whether or not the power transmitter is close to a position where power transmission to the power receiver is allowed, and rotate the power transmitter by a predetermined angle or move the power transmitter by a predetermined distance toward the position where the power transmission is allowed until determining that the power transmitter is close to the position where the power transmission is allowed.

According to this configuration, the power transmitter can be moved by a predetermined distance or rotated by a predetermined angle until the power transmitter approaches a position where power can be transmitted to the power receiver, and the power transmitter can be appropriately brought close to the position where power can be transmitted to the power receiver.

(10) The wireless charging device according to any one of (1) to (9) may further include an authentication unit that acquires a token of the moving body and authenticates whether or not the token is issued by a provider of the moving body, in which the detection unit, the acquisition unit, the identification unit, and the charge control unit may operate in a case where the token is authenticated to be issued by the provider.

According to this configuration, the detection unit, the acquisition unit, the identification unit, and the charge control unit operate in a case where a token of the moving body is issued by a provider of the moving body. By the above, the power transmitter approaches the power receiver of the moving body. For this reason, it is possible to avoid transmission of power to a power receiver of a moving body having an unauthorized token that is not issued by a provider of the moving body by bringing the power transmitter close to the power receiver.

(11) The wireless charging device according to (10) may further include a measurement unit that measures an amount of power transmitted from the power transmitter to the power receiver, in which the charge control unit may further output, in a case where completion of power reception of power by the power receiver is detected, information in which identification information of the wireless charging device, identification information of the provider, identification information of the moving body, and information on the amount of power measured by the measurement unit from start to completion of power transmission of the power are associated with each other.

According to this configuration, in a case where completion of power reception by the power receiver is detected, information in which identification information of the wireless charging device, identification information of a provider of the moving body, identification information of the moving body, and information on an amount of power measured from start to completion of power transmission of the power are associated with each other is output.

For this reason, by referring to output information, a provider of the moving body can grasp which moving body provided by the provider is charged with how much power from which wireless charging device.

(12) A wireless charging method according to another aspect of the present disclosure is a wireless charging method in a wireless charging device including a power transmitter that wirelessly transmits power to a power receiver included in an electric moving body, and a moving mechanism that moves the power transmitter, the method including, by a computer of the wireless charging device, detecting a stop position of the moving body, acquiring information indicating a type of the moving body, identifying an attachment position of the power receiver based on the type, and controlling the moving mechanism based on the stop position and the attachment position to bring the power transmitter close to the power receiver.

According to this configuration, the same operation and effect as those of the wireless charging device according to (1) can be obtained.

(13) A non-transitory computer readable storage medium according to another aspect of the present disclosure is a non-transitory computer readable storage medium storing a program that causes a computer of a wireless charging device including a power transmitter that wirelessly transmits power to a power receiver included in an electric moving body and a moving mechanism that moves the power transmitter to function as a detection unit that detects a stop position of the moving body, an acquisition unit that acquires information indicating a type of the moving body, an identification unit that identifies an attachment position of the power receiver based on the type, and a charge control unit that controls the moving mechanism based on the stop position and the attachment position to bring the power transmitter close to the power receiver.

According to this configuration, the same operation and effect as those of the wireless charging device according to (1) can be obtained. It is needless to say that the present disclosure can allow such a computer program to be distributed using a computer-readable non-transitory recording medium such as a CD-ROM, or via a communication network such as the Internet.

Note that all embodiments described below describe a specific example of the present disclosure. Numerical values, shapes, constituents, steps, order of steps, and the like shown in the embodiment below are merely examples, and are not intended to limit the present disclosure. Further, a constituent that is not described in an independent claim representing the highest concept among constituents in the embodiment below is described as an optional constituent. Further, in all the embodiments, content of each of the embodiments can be combined.

Hereinafter, an embodiment of the present disclosure will be described with reference to the drawings.

### Embodiment

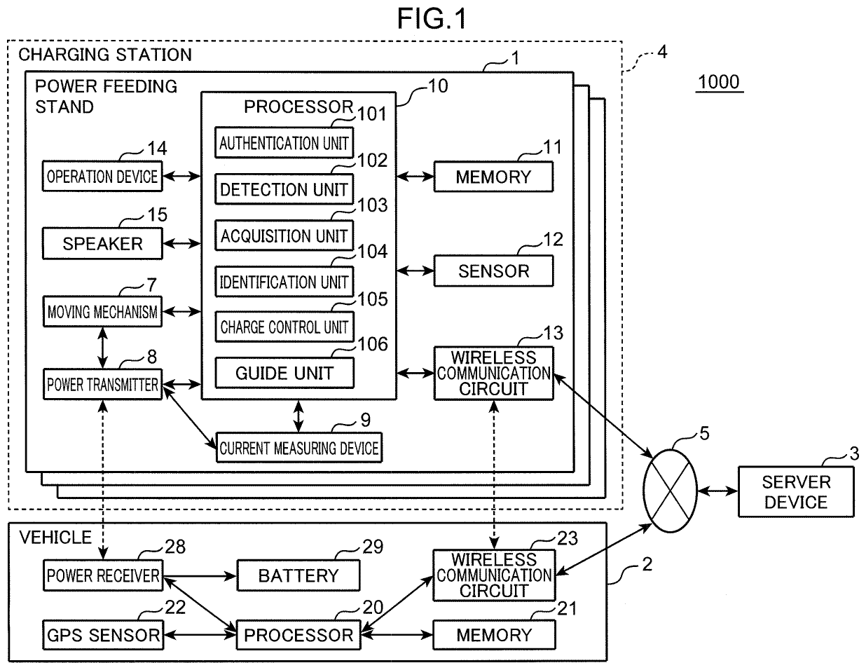

FIG. 1 is a diagram illustrating an example of an overall configuration of a wireless charging system 1000. The wireless charging system 1000 according to an embodiment of the present disclosure includes a rechargeable electric vehicle 2 (an example of a moving body), a plurality of power feeding stands 1 (an example of a wireless charging device) installed in a charging station 4, and a server device 3.

In the charging station 4, in order to charge the vehicle 2 of one or more vehicle types (an example of types) provided by one or more service providers, a plurality of the power feeding stands 1 that can be shared by the vehicles 2 of the one or more vehicle types are installed side by side. The vehicle 2 and a plurality of the power feeding stands 1 are communicably connected to the server device 3 via a network 5. The network 5 includes, for example, a wide area network (WAN) including the Internet, a mobile phone communication network, and the like. Further, each of a plurality of the power feeding stands 1 can directly perform near field communication with another one of the power feeding stands 1. The wireless charging system 1000 allows the vehicle 2 stopped in the vicinity of the power feeding stand 1 installed in the charging station 4 to be charged in a non-contact state by the power feeding stand 1.

Hereinafter, detailed configurations of the vehicle 2, the server device 3, and the power feeding stand 1 will be described.

As the vehicle 2, for example, a small electric vehicle that one or two users can ride, such as an electric bicycle, an electric motorcycle, and an electric kick scooter, is employed. The vehicle 2 includes a memory 21, a global positioning system (GPS) sensor 22, a wireless communication circuit 23 (an example of a receiving circuit), a battery 29, a power receiver 28, and a processor 20.

The memory 21 includes, for example, a nonvolatile rewritable semiconductor memory such as a flash memory. The memory 21 stores a program executed by the processor 20, identification information of the vehicle 2, information (hereinafter, vehicle type information) indicating a vehicle type of the vehicle 2, a token (authentication information) provided from a service provider (hereinafter, a provider of the vehicle 2) as a provider of the vehicle 2, identification information of a provider of the vehicle 2, and the like. The vehicle type information of the vehicle 2 includes information indicating whether the vehicle 2 is an electric automobile, an electric motorcycle, or an electric kick scooter, and a model number of the vehicle 2.

The GPS sensor 22 is a sensor that detects a current position of the vehicle 2. Specifically, the GPS sensor 22 detects latitude, longitude, and altitude indicating a current position of the vehicle 2.

The wireless communication circuit 23 performs wireless communication with the server device 3 via the network 5. Further, when approaching the power feeding stand 1 installed in the charging station 4, the wireless communication circuit 23 performs near field communication using a beacon signal such as Bluetooth (registered trademark) with the power feeding stand 1.

The battery 29 holds electric power for driving the vehicle 2. For example, a lithium ion battery is employed as the battery 29.

The power receiver 28 receives power wirelessly transmitted from the power feeding stand 1, and charges the battery 29 with the received power. Further, the power receiver 28 periodically estimates a state of charge (SOC) of the battery 29, and when the power receiver 28 estimates that the state of charge of the battery 29 is 100%, the charging of the battery 29 is completed.

The processor 20 includes a central processing unit (CPU). The processor 20 controls operation of each unit of the vehicle 2.

For example, the processor 20 transmits various types of information to the server device 3 by using the wireless communication circuit 23. Specifically, the processor 20 transmits information (hereinafter, movement history information) indicating a movement history of the vehicle 2 to the server device 3 periodically (for example, every 30 seconds).

The movement history information includes information indicating current date and time (hereinafter, current date and time information), identification information and vehicle type information of the vehicle 2 stored in the memory 21, and information indicating a current position of the vehicle 2 detected by the GPS sensor 22.

Further, in a case where the vehicle 2 approaches the power feeding stand 1 and the wireless communication circuit 23 receives a beacon signal transmitted from the power feeding stand 1, the processor 20 returns a beacon signal including various types of information to the power feeding stand 1 by using the wireless communication circuit 23. For example, the processor 20 acquires vehicle type information and a token stored in the memory 21, and returns the vehicle type information and the token to the power feeding stand 1.

Further, the processor 20 acquires a state of charge of the battery 29 estimated by the power receiver 28. In a case of detecting that an acquired state of charge is a predetermined state of charge (for example, 100%), the processor 20 transmits information (hereinafter, charge completion information) indicating that the charging of the battery 29 is completed to the power feeding stand 1 by using the wireless communication circuit 23.

Note that the vehicle 2 may further include an operation device (not illustrated) for prompting the user to perform various types of operation to use the vehicle 2 and a display (not illustrated) for displaying various types of information.

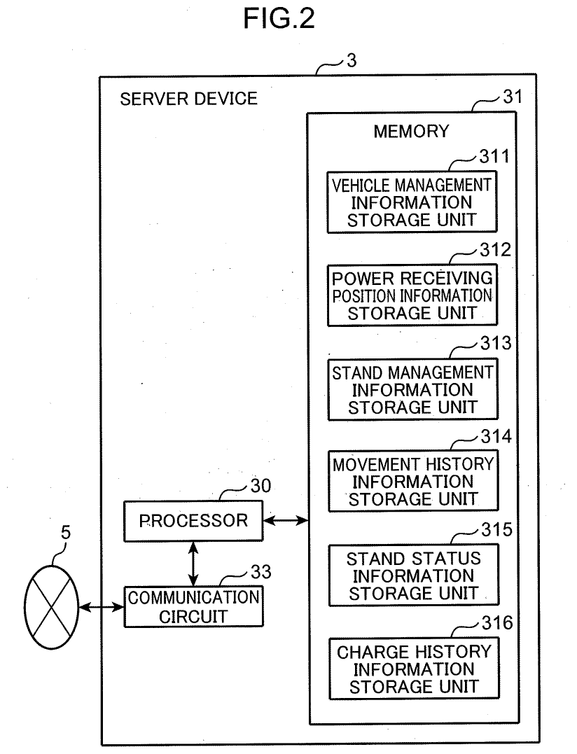

Next, a configuration of the server device 3 will be described. FIG. 2 is a diagram illustrating an example of a configuration of the server device 3. As the server device 3, a cloud server including one or more computers including a processor such as a central processing unit (CPU), a memory, and a communication circuit that communicates with an external device via the network 5 is employed. As illustrated in FIG. 2, the server device 3 includes a communication circuit 33, a memory 31, and a processor 30.

The communication circuit 33 communicates with the power feeding stand 1 and the vehicle 2 via the network 5.

The memory 31 includes, for example, a nonvolatile rewritable semiconductor memory such as a flash memory, a hard disk drive (HDD), or the like. The memory 31 stores a program executed by the processor 30. Further, the memory 31 also includes a vehicle management information storage unit 311, a power receiving position information storage unit 312, a stand management information storage unit 313, a movement history information storage unit 314, a stand status information storage unit 315, and a charge history information storage unit 316.

The vehicle management information storage unit 311 stores information (hereinafter, vehicle management information) for managing the vehicle 2 provided by one or more service providers. The vehicle management information includes identification information of the vehicle 2, vehicle type information of the vehicle 2, identification information of a service provider that provides the vehicle 2, information for authenticating a token provided to the vehicle 2, and the like. The information for authenticating a token is information for authenticating whether or not a token is issued by a provider. For example, in a case where a token is encrypted information, the information for authenticating a token is information indicating a key used for determining whether or not the token can be decrypted.

The power receiving position information storage unit 312 stores, for each of a plurality of vehicle types for classifying a plurality of the vehicles 2 sold by a vehicle manufacturer, information (hereinafter, power receiving position information) defining an attachment position of the power receiver 28 in the vehicle 2 of each vehicle type.

Specifically, the power receiving position information is information in which a vehicle type (for example, “electric bicycle model A”), a predetermined portion (for example, “central portion of a handlebar”) in the vehicle 2 of the vehicle type, and a relative position (for example, “A1 cm, A2 cm, −A3 cm (A1, A2, A3>0)”) of the power receiver 28 when the predetermined portion is used as a reference are associated with each other. Note that, in the present embodiment, the predetermined portion is defined as a portion where the wireless communication circuit 23 is installed. However, the predetermined portion is not limited to this, and may be determined as a portion (for example, in a case of an electric kick scooter, a central portion of a handlebar) at a leading end in a traveling direction of the vehicle 2.

The stand management information storage unit 313 stores information (hereinafter, stand management information) for managing each of a plurality of the power feeding stands 1 installed in the charging station 4. The stand management information includes identification information of the power feeding stand 1, identification information of the charging station 4 in which the power feeding stand 1 is installed, information indicating an installation position of the power feeding stand 1, and the like.

Movement history information periodically transmitted from the vehicle 2 is stored in the movement history information storage unit 314.

The stand status information storage unit 315 stores information (hereinafter, stand status information) indicating a use status of the power feeding stand 1 periodically transmitted from the power feeding stand 1. The stand status information includes identification information of the power feeding stand 1, information indicating a state of the power feeding stand 1, and the like.

The state of the power feeding stand 1 includes an empty state in which the vehicle 2 is not stopped in the vicinity of the power feeding stand 1, a state in which the vehicle 2 is stopped in the vicinity of the power feeding stand 1 but power transmission is not started, a state in which power is being transmitted, a state in which power transmission is completed, and the like. Further, in a case where the power feeding stand 1 is in a state in which power is being transmitted, stand status information includes remaining time until the power transmission is completed.

The charge history information storage unit 316 stores information indicating a history of power transmission to the vehicle 2 by the power feeding stand 1 (hereinafter, charge history information). The charge history information is information in which identification information of the power feeding stand 1, identification information of the vehicle 2 that receives power transmitted from the power feeding stand 1, identification information of a provider of the vehicle 2, and information on an amount of power transmitted from the power feeding stand 1 from start to completion of the power transmission to the vehicle 2 by the power feeding stand 1 are associated with each other.

The processor 30 includes a central processing unit (CPU). The processor 30 controls each unit of the server device 3. For example, the processor 30 acquires various types of information received by the communication circuit 33 from the vehicle 2 and the power feeding stand 1.

Specifically, the processor 30 acquires movement history information received by the communication circuit 33 from the vehicle 2, and stores the movement history information in the movement history information storage unit 314. Further, the processor 30 acquires stand status information received by the communication circuit 33 from the power feeding stand 1, and stores the stand status information in the stand status information storage unit 315. The processor 30 acquires charge history information received by the communication circuit 33 from the power feeding stand 1, and stores the charge history information in the charge history information storage unit 316.

Next, a configuration of the power feeding stand 1 will be described. As illustrated in FIG. 1, the power feeding stand 1 includes a memory 11, a wireless communication circuit 13, an operation device 14, a speaker 15, a power transmitter 8, a moving mechanism 7, a current measuring device 9, and a processor 10 (an example of a computer).

The memory 11 includes, for example, a nonvolatile rewritable semiconductor memory such as a flash memory. The memory 11 stores a program executed by the processor 10, identification information of the power feeding stand 1, and the like.

A sensor 12 includes a short-range communication circuit that performs near field communication using a beacon signal such as Bluetooth (registered trademark). The sensor 12 periodically transmits a beacon signal, and detects a direction from an arrangement position of the sensor 12 toward a position where the beacon signal is received.

The wireless communication circuit 13 performs wireless communication with the server device 3 via the network 5. Further, the wireless communication circuit 13 performs near field communication using a beacon signal such as Bluetooth (registered trademark) with the vehicle 2 approaching the power feeding stand 1. Note that the wireless communication circuit 13 may be configured using a near field communication circuit having a detection function similar to that of the sensor 12, and may also be used as the sensor 12.

The operation device 14 is a device that receives operation of the power feeding stand 1 by the user. Specifically, the operation device 14 includes a touch panel unit or the like in which a touch panel and a liquid crystal display are combined. The operation device 14 displays various operation screens and information on a liquid crystal display, and receives an operation instruction corresponding to a soft key touched by the user on an operation screen. Note that the operation device 14 may include a hard key for inputting various operation instructions.

The speaker 15 outputs voice instructed by the processor 10 under control of the processor 10.

The power transmitter 8 wirelessly transmits power to the power receiver 28 included in the vehicle 2 under control of the processor 10. The moving mechanism 7 three-dimensionally moves the power transmitter 8 under control of the processor 10. Details of the power transmitter 8 and the moving mechanism 7 will be described later.

The current measuring device 9 measures an amount of power transmitted to the power receiver 28 by the power transmitter 8. Specifically, the current measuring device 9 measures a current value supplied to the power transmitter 8. The current measuring device 9 outputs an integrated value of current values measured within unit time to the processor 10 as an amount of power transmitted to the power receiver 28 per unit time every predetermined unit time.

The processor 10 includes a central processing unit (CPU). The processor 10 functions as an authentication unit 101, a detection unit 102, an acquisition unit 103, an identification unit 104, a charge control unit 105, and a guide unit 106 by executing a program stored in the memory 11.

The authentication unit 101 acquires a token from the vehicle 2 present in the vicinity of the power feeding stand 1, and authenticates whether or not the token is issued by a service provider that provides the vehicle 2.

Specifically, upon receiving a beacon signal transmitted by the wireless communication circuit 13, the wireless communication circuit 23 of the vehicle 2 present within a near field communication range with the wireless communication circuit 13 returns a beacon signal including a token stored in the memory 21 of the vehicle 2 and identification information of the vehicle 2. By the above, the acquisition unit 103 acquires the token and the identification information of the vehicle 2 included in the beacon signal received by the wireless communication circuit 13.

The authentication unit 101 transmits, to the server device 3 by using the wireless communication circuit 13, the acquired token and identification information of the vehicle 2, as well as information for requesting authentication of whether or not the token is issued by a provider of the vehicle 2 (hereinafter, authentication request information).

In the server device 3, when the communication circuit 33 receives authentication request information, the processor 30 acquires vehicle management information including identification information of the vehicle 2 received together with the authentication request information from the vehicle management information storage unit 311. The processor 30 authenticates whether or not a token received together with authentication request information is issued by a provider of the vehicle 2 by using information for authenticating a token included in the vehicle management information. Then, the processor 30 returns information (hereinafter, authentication result information) indicating a result of the authentication by using the communication circuit 33.

In accordance with content indicated by authentication result information received by the wireless communication circuit 13, the authentication unit 101 authenticates whether or not a token acquired from the vehicle 2 present within a near field communication range with the wireless communication circuit 13 is issued by a service provider that provides the vehicle 2.

Note that a method of authenticating a token by the authentication unit 101 is not limited to this. For example, the authentication unit 101 may transmit information (hereinafter, transmission request information) requesting transmission of vehicle management information including identification information of the vehicle 2 together with identification information of the vehicle 2 acquired from the vehicle 2 present within a near field communication range with the wireless communication circuit 13 to the server device 3 using the wireless communication circuit 13.

In this case, in the server device 3, when the communication circuit 33 receives transmission request information, the processor 30 acquires vehicle management information including identification information of the vehicle 2 received together with the transmission request information from the vehicle management information storage unit 311, and returns the vehicle management information by using the communication circuit 33. The authentication unit 101 authenticates whether or not a token acquired from the vehicle 2 is issued by a provider of the vehicle 2 by using information for authenticating a token included in vehicle management information returned from the server device 3.

The detection unit 102 detects a position of the vehicle 2 present in the vicinity of the power feeding stand 1 by using the sensor 12. Details of a method of detecting a position of the vehicle 2 by using the sensor 12 by the detection unit 102 will be described later.

The acquisition unit 103 acquires information on the vehicle 2 from the vehicle 2 stopped in the vicinity of the power feeding stand 1. The information on the vehicle 2 includes identification information of the vehicle 2, vehicle type information of the vehicle 2, and identification information of a provider of the vehicle 2.

Specifically, when receiving a beacon signal transmitted from the wireless communication circuit 13, the wireless communication circuit 23 of the vehicle 2 stopped within a near field communication range with the wireless communication circuit 13 returns a beacon signal including identification information and vehicle type information of the vehicle 2, and identification information of a provider of the vehicle 2 stored in the memory 21. By the above, the acquisition unit 103 acquires identification information and vehicle type information of the vehicle 2 stopped in the vicinity of the power feeding stand 1 and identification information of a provider of the vehicle 2 included in a beacon signal received by the wireless communication circuit 13.

Note that information included in a beacon signal returned to the wireless communication circuit 13 by the wireless communication circuit 23 of the vehicle 2 stopped within a near field communication range with the wireless communication circuit 13 is not limited to the above. The wireless communication circuit 23 may return a beacon signal including at least identification information of the vehicle 2. In conjunction with this, the acquisition unit 103 may acquire, from the server device 3, vehicle type information of the vehicle 2 and/or identification information of a provider of the vehicle 2, which are not included in a beacon signal and correspond to identification information of the vehicle 2 included in the beacon signal.

This configuration can be realized as described below, for example. The acquisition unit 103 acquires identification information of the vehicle 2 included in a beacon signal. The acquisition unit 103 transmits, to the server device 3, information (hereinafter, vehicle management request information) requesting transmission of vehicle management information corresponding to identification information of the vehicle 2 together with the identification information of the vehicle 2. In the server device 3, when the communication circuit 33 receives the vehicle management request information, the processor 30 acquires vehicle management information corresponding to identification information of the vehicle 2 received together with the vehicle management request information from the vehicle management information storage unit 311, and returns the vehicle management information by using the communication circuit 33. The acquisition unit 103 acquires vehicle type information of the vehicle 2 and/or identification information of a provider of the vehicle 2, which are included in vehicle management information received by the wireless communication circuit 13 and are not included in a beacon signal.

Based on a vehicle type indicated by vehicle type information acquired by the acquisition unit 103, the identification unit 104 identifies an attachment position of the power receiver 28 included in the vehicle 2 stopped in the vicinity of the power feeding stand 1.

Specifically, together with vehicle type information acquired by the acquisition unit 103, the identification unit 104 transmits information (hereinafter, power receiving position request information) requesting transmission of power receiving position information corresponding to the vehicle type information to the server device 3 by using the wireless communication circuit 13. In the server device 3, when the communication circuit 33 receives power receiving position request information, the processor 30 acquires power receiving position information corresponding to a vehicle type indicated by vehicle type information received together with the power receiving position request information from the power receiving position information storage unit 312, and returns the power receiving position information by using the communication circuit 33.

The identification unit 104 acquires power receiving position information received by the wireless communication circuit 13. The identification unit 104 identifies a relative position of the power receiver 28 when a predetermined portion is used as a reference indicated by acquired power receiving position information as an attachment position of the power receiver 28 included in the vehicle 2 stopped in the vicinity of the power feeding stand 1.

The charge control unit 105 controls the moving mechanism 7 based on a stop position (an example of a stop position) of the vehicle 2 stopped in the vicinity of the power feeding stand 1 and an attachment position of the power receiver 28 in the vehicle 2, and brings the power transmitter 8 close to the power receiver 28 included in the vehicle 2. Details of control of the moving mechanism 7 by the charge control unit 105 will be described later.

After bringing the power transmitter 8 close to the power receiver 28, the charge control unit 105 causes the power transmitter 8 to start power transmission to the power receiver 28. Further, the charge control unit 105 causes the current measuring device 9 to start measurement of an amount of power transmitted to the power receiver 28 by the power transmitter 8.

In a case of detecting completion of receiving of power by the power receiver 28, the charge control unit 105 outputs charge history information. The charge history information is information in which identification information of the power feeding stand 1, identification information of the vehicle 2 having the power receiver 28, information indicating a provider of the vehicle 2, and information on an amount of power measured by the current measuring device 9 from start to completion of transmission of the power are associated with each other. The information on an amount of power includes an amount of power per unit time measured by the current measuring device 9 and date and time when the current measuring device 9 measures the amount of power.

Specifically, in a case where the wireless communication circuit 13 receives charge completion information from the vehicle 2, the charge control unit 105 detects completion of receiving of power by the power receiver 28. In this case, the charge control unit 105 transmits, to the server device 3 by using the wireless communication circuit 13, charge history information in which identification information of the power feeding stand 1 stored in the memory 11, identification information of the vehicle 2 and information indicating a provider of the vehicle 2 acquired by the acquisition unit 103, and information on an amount of power measured by the current measuring device 9 from start to completion of power transmission to the power receiver 28 of the vehicle 2 are associated with each other.

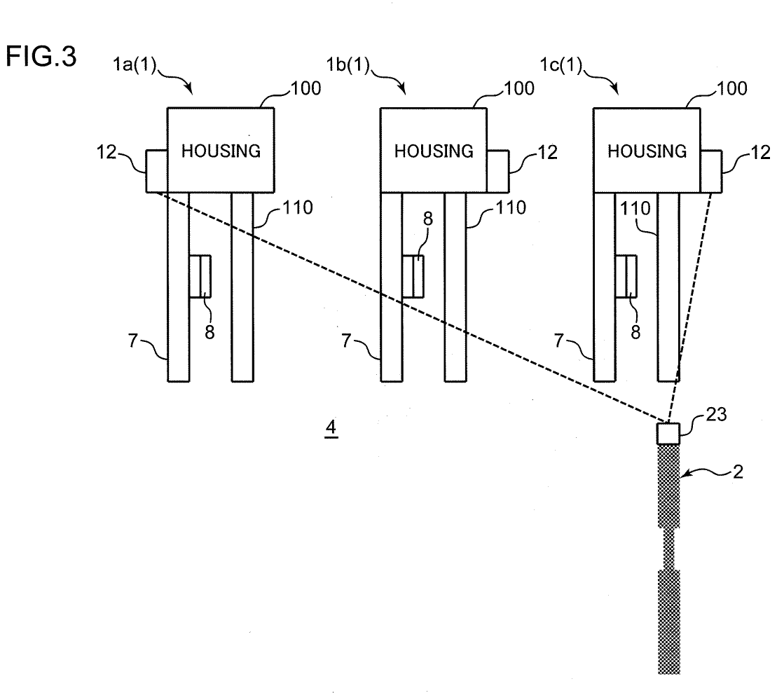

The guide unit 106 determines whether or not a stop position of the vehicle 2 detected by the detection unit 102 is within a predetermined stop lane 110 (FIG. 3). The stop lane 110 (an example of a stop area) is provided within a near field communication range with the wireless communication circuit 23 as an area where the vehicle 2 to be charged by the power feeding stand 1 is stopped.

Information indicating a position of the vehicle stop lane 110 is stored in the memory 11. That is, the guide unit 106 determines whether or not a stop position of the vehicle 2 detected by the detection unit 102 is within the predetermined stop lane 110 (FIG. 2) with reference to information indicating a position of the stop lane 110 stored in the memory 11.

In a case of determining that a stop position of the vehicle 2 is outside the stop lane 110, the guide unit 106 guides the vehicle 2 to stop again in the stop lane 110 (FIG. 2). Specifically, in a case of determining that a stop position of the vehicle 2 is outside the stop lane 110, the guide unit 106 displays a message (for example, “please stop the vehicle 2 again in the stop lane”) for guiding the vehicle 2 to be stopped again in the stop lane 110 (FIG. 2) on a liquid crystal display included in the operation device 14.

Note that the present invention is not limited to this, and the guide unit 106 may control the speaker 15 to output voice (for example, “please stop the vehicle 2 again in the stop lane”) for guiding the vehicle 2 to be stopped again in the stop lane 110 (FIG. 2).

### (Method of Detecting Position of Vehicle 2)

Next, details of a method of detecting a position of the vehicle 2 using the sensor 12 by the detection unit 102 will be described. FIG. 3 is a diagram illustrating an example of a method of detecting a position of the vehicle 2.

FIG. 3 is a plan view of the charging station 4, illustrating an example in which three power feeding stands 1a, 1b, and 1c are installed side by side in the charging station 4. The sensor 12 is installed on a side surface of a housing 100 of each of three of the power feeding stands 1a, 1b, and 1c. In front of the housing 100 of each of three of the power feeding stands 1a, 1b, and 1c, the moving mechanism 7 and the stop lane 110 for stopping the vehicle 2 charged by each of the power feeding stands 1 are installed side by side.

The housing 100 accommodates the processor 10, the memory 11, the wireless communication circuit 13, and the current measuring device 9. The operation device 14 and the speaker 15 are provided on an outer surface of the housing 100. Further, the wireless communication circuit 23 is provided at a tip portion of a vehicle body of the vehicle 2.

Assume that the vehicle 2 arrives in the charging station 4 and approaches a near field communication range where it is possible to receive a beacon signal transmitted from the sensor 12 of each of three of the power feeding stands 1a, 1b, and 1c. In this case, the wireless communication circuit 23 of the vehicle 2 receives a beacon signal transmitted from the sensors 12 of three of the power feeding stands 1a, 1b, and 1c, and returns a beacon signal indicating the reception. By the above, based on the beacon signal returned from the wireless communication circuit 23 of the vehicle 2, each of the sensors 12 of three of the power feeding stands 1a, 1b, and 1c detects a direction from its own position toward the wireless communication circuit 23 of the vehicle 2 that receives the beacon signal.

The detection unit 102 of each of the power feeding stands 1 transmits information indicating a direction detected by the sensor 12 of each of the power feeding stands 1 to another one of the power feeding stands 1 by short-range communication using the wireless communication circuit 13. The information indicating a direction detected by the sensor 12 is, for example, information indicating an angle formed by a reference direction and a direction detected by the sensor 12 when a front direction of the sensor 12 is set as the reference direction.

The detection unit 102 of each of the power feeding stands 1 acquires a direction detected by the sensor 12 included in each of the power feeding stands 1 and a direction detected by the sensor 12 of another one of the power feeding stands 1. The detection unit 102 of each of the power feeding stands 1 detects, as a position where the wireless communication circuit 23 of the vehicle 2 is present, a position of an intersection of straight lines (broken lines in FIG. 3) extending in a direction detected by the sensors 12 from arrangement positions of the sensors 12. Note that an installation position of each of the power feeding stands 1 and an arrangement position of each of the sensors 12 are stored in advance in the memory 11 of each of the power feeding stands 1.

As described above, the detection unit 102 detects a position of the vehicle 2 based on directions detected by the sensor 12 included in the power feeding stand 1 including the detection unit 102 and the sensor 12 included in another one of the power feeding stands 1. For this reason, it is possible to detect a position of the vehicle 2 at low cost as compared with a case where the charging station 4 includes a high-resolution monitoring camera and a position of the vehicle 2 is detected from a captured image of the monitoring camera.

### (Details of Power Transmitter 8 and Moving Mechanism 7)

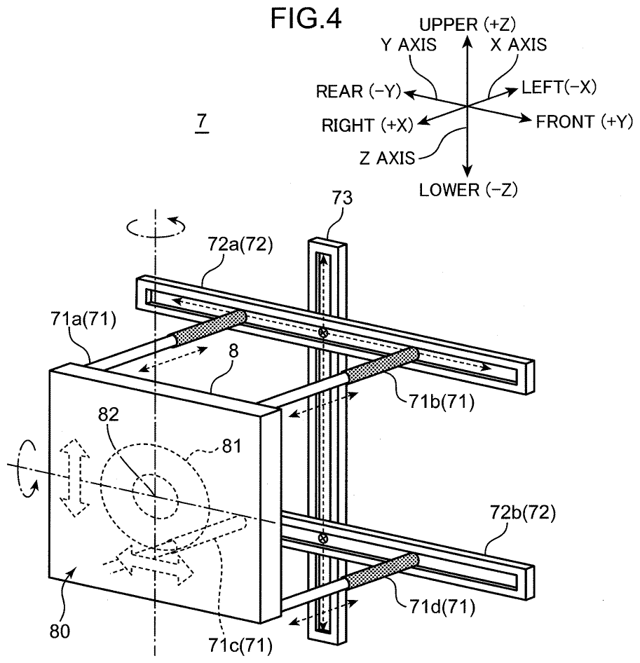

Next, details of the power transmitter 8 and the moving mechanism 7 will be described. FIG. 4 is a perspective view illustrating an example of the power transmitter 8 and the moving mechanism 7. In description below, as illustrated in the upper right of FIG. 4, a direction parallel to the ground on which the moving mechanism 7 is installed and a power transmission surface 80 of power of the power transmitter 8 is referred to as a front-rear direction or a Y direction (an example of a first direction). A direction orthogonal to the ground on which the moving mechanism 7 is installed is referred to as a vertical direction or a Z direction (an example of a second direction). A direction orthogonal to the front-rear direction (Y direction) and the vertical direction (Z direction) is referred to as a left-right direction or an X direction (an example of a third direction).

The power transmitter 8 includes the power transmission surface 80 and a power supply coil 81. The power supply coil 81 is built in the power transmitter 8 and is configured to be movable in the vertical direction and the front-rear direction along the power transmission surface 80. The power transmitter 8 causes current to flow through the power supply coil 81 in a state of approaching the power receiver 28, so as to generate a magnetic field in the power supply coil 81. As a result, current flows through an induction coil built in the power receiver 28 by an electromagnetic induction action. As described above, the power transmitter 8 wirelessly transmits power to the approaching power receiver 28 by an electromagnetic induction action.

Further, a position detection circuit (not illustrated) is incorporated in the power transmitter 8. The position detection circuit detects whether or not an induction coil of the power receiver 28 is at a position facing the power supply coil 81 and is within a predetermined distance from the power supply coil 81.

The moving mechanism 7 includes four left-right arms 71a to 71d, two front-rear rails 72a and 72b, and a vertical rail 73.

Each of four of the left-right arms 71a to 71d is configured to be able to expand and contract in the left-right direction under control of the processor 10. One end on the right side (+X direction) of each of four of the left-right arms 71a to 71d is connected to the power transmitter 8 by a ball joint.

One end on the left side (−X direction) of two of the left-right arms 71a and 71b on the upper side (+Z direction) is connected to the front-rear rail 72a so as to be slidable in the front-rear direction along the front-rear rail 72a on the upper side (+Z direction). One end on the left side (−X direction) of two of the left-right arms 71c and 71d on the lower side (−Z direction) is connected to the front-rear rail 72b so as to be slidable in the front-rear direction along the front-rear rail 72b on the lower side (−Z direction).

Central portions of two of the front-rear rails 72a and 72b are connected to the vertical rail 73 so as to be slidable in the vertical direction along the vertical rail 73.

That is, under control of the processor 10, the moving mechanism 7 is configured to slide two of the left-right arms 71a and 71b on the upper side (+Z direction) in the front-rear direction (Y direction) along the front-rear rail 72a, and simultaneously slide two of the left-right arms 71c and 71d on the lower side (−Z direction) in the front-rear direction (Y direction) along the front-rear rail 72b at the same speed as two of the left-right arms 71a and 71b, so that the power transmitter 8 can move along the front-rear direction (Y direction).

The moving mechanism 7 is configured to be capable of moving the power transmitter 8 along the vertical direction (Z direction) by simultaneously sliding two of the front-rear rails 72a and 72b along the vertical rail 73 at the same speed in the vertical direction (Z direction) under control of the processor 10.

Further, the moving mechanism 7 is configured to be capable of moving the power transmitter 8 along the left-right direction (X direction) by simultaneously expanding and contracting four of the left-right arms 71a to 71d at the same speed under control of the processor 10.

Furthermore, the moving mechanism 7 is configured to be capable of rotating the power transmitter 8 about the Y axis parallel to the front-rear direction (Y direction) by simultaneously expanding and contracting two of the left-right arms 71a and 71b on the upper side (+Z direction) and two of the left-right arms 71c and 71d on the lower side (−Z direction) in different directions at the same speed.

Similarly, the moving mechanism 7 is configured to be capable of rotating the power transmitter 8 about the Z axis parallel to the vertical direction (Z direction) by simultaneously expanding and contracting two of the left-right arms 71b and 71d on the front side (+Y direction) and two of the left-right arms 71a and 71c on the rear side (−Y direction) in different directions at the same speed.

Furthermore, the moving mechanism 7 is configured to be able to incline (by, for example, 0 to 45 degrees) the power transmission surface 80 about the Y axis parallel to the front-rear direction (Y direction) by simultaneously expanding and contracting only one pair of left-right arms of a pair of the left-right arms 71a and 71b on the upper side (+Z direction) and a pair of the left-right arms 71c and 71d on the lower side (−Z direction).

Similarly, the moving mechanism 7 is configured to be able to incline (by, for example, 0 to 45 degrees) the power transmission surface 80 about the Z axis parallel to the vertical direction (Z direction) by simultaneously expanding and contracting only one pair of left-right arms of a pair of the left-right arms 71b and 71d on the front side (+Y direction) and a pair of the left-right arms 71a and 71c on the rear side (−Y direction).

### (Details of Wireless Charging Processing)

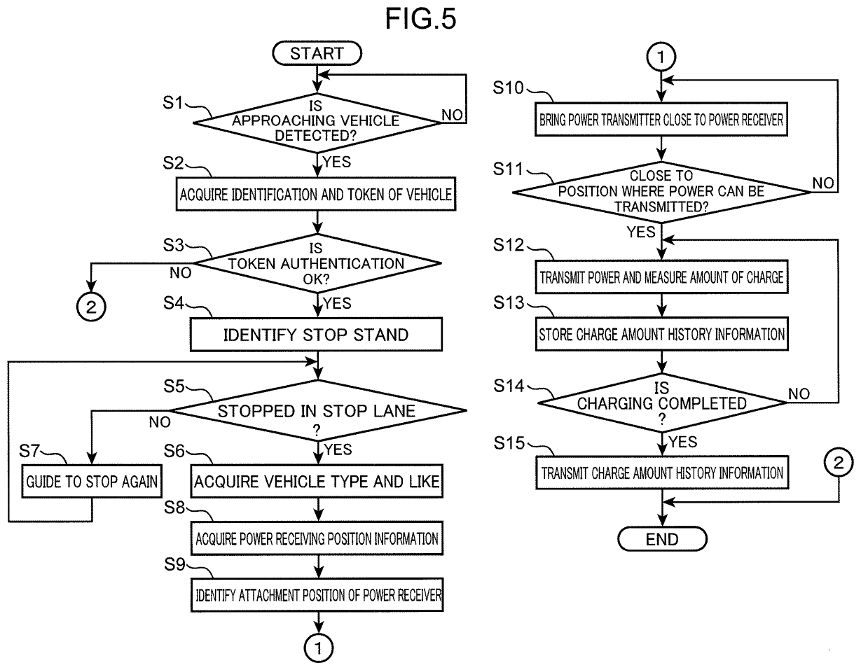

Next, processing (hereinafter, wireless charging processing) of charging the vehicle 2 stopped in the vicinity of the power feeding stand 1 installed in the charging station 4 in a non-contact state by the power feeding stand 1 in the wireless charging system 1000 will be described with reference to FIG. 5. FIG. 5 is a flowchart illustrating an example of the wireless charging processing.

When the authentication unit 101 waits until the vehicle 2 approaches the power feeding stand 1 (NO in Step S1) and detects that the vehicle 2 approaches the power feeding stand 1 (YES in Step S1), the authentication unit 101 acquires identification information of the vehicle 2 and a token of the vehicle 2 from the vehicle 2 (Step S2).

Specifically, as described above, when the vehicle 2 moves within a near field communication range with the wireless communication circuit 13 of the power feeding stand 1, the wireless communication circuit 23 of the vehicle 2 receives a beacon signal transmitted from the wireless communication circuit 13, and returns a beacon signal including identification information and a token of the vehicle 2 to the wireless communication circuit 13. In Step S1, the authentication unit 101 detects that the vehicle 2 approaches the power feeding stand 1 when the wireless communication circuit 13 receives a beacon signal including identification information and a token of the vehicle 2. In Step S2, the authentication unit 101 acquires the identification information and the token of the vehicle 2 included in the beacon signal received by the wireless communication circuit 13.

Next, as described above, the authentication unit 101 authenticates whether or not the token acquired in Step S2 is issued by a provider of the vehicle 2 (Step S3). In a case where the authentication unit 101 authenticates that the token acquired in Step S2 is not issued by a provider of the vehicle 2 (NO in Step S3), the wireless charging processing ends.

On the other hand, in Step S3, in a case where it is authenticated that the token acquired in Step S2 is issued by a provider of the vehicle 2 (YES in Step S3), processing in and after Step S4 is performed, and the detection unit 102, the acquisition unit 103, the identification unit 104, and the charge control unit 105 operate.

In Step S4, the detection unit 102 identifies the power feeding stand 1 (hereinafter, stop stand) at which the vehicle 2 is stopped from among a plurality of the power feeding stands 1 provided in the charging station 4 (Step S4).

Specifically, in Step S4, in a case where a position of the vehicle 2 detected as described above does not change for a certain period of time or more, the detection unit 102 determines that the vehicle 2 is stopped. In this case, the detection unit 102 refers to an installation position of each of the power feeding stands 1 stored in the memory 11, and identifies the power feeding stand 1 installed at a position closest to a position of the detected vehicle 2 as a stop stand.

Hereinafter, processing in and after Step S5 will be described. Processing in and after Step S5 is performed by the processor 10 of a stop stand. Steps S1 to S4 may be performed by the processor 10 of one other than a stop stand.

The guide unit 106 determines whether or not a stop position of the vehicle 2 detected by the detection unit 102 is within the stop lane 110 for stopping the vehicle 2 to be charged by the stop stand identified in Step S4 (Step S5).

In Step S5, in a case of determining that a stop position of the vehicle 2 is outside the stop lane 110 (NO in Step S5), the guide unit 106 guides the vehicle 2 to be stopped again in the stop lane 110 (FIG. 2) (Step S7).

Specifically, in Step S7, the guide unit 106 displays, on a liquid crystal display included in the operation device 14, a message (for example, “please stop the vehicle 2 again in the stop lane”) for guiding the vehicle 2 to be stopped again in the stop lane 110 (FIG. 2). Further, the guide unit 106 may display a message (for example, “please move the vehicle 2 rightward by about 1 m”) indicating in which direction and by what distance the vehicle 2 should be moved in order to move a stop position of the vehicle 2 into the stop lane 110 on a liquid crystal display included in the operation device 14.

Note that, similarly, the guide unit 106 may control the speaker 15 to output voice (for example, “please stop the vehicle 2 again in the stop lane”) for guiding the vehicle 2 to be stopped again in the stop lane 110 (FIG. 2). Further, the guide unit 106 may control the speaker 15 to output voice (for example, “please move the vehicle 2 rightward by about 1 m”) indicating in which direction and by what distance the vehicle 2 should be moved in order to move a stop position of the vehicle 2 into the stop lane 110.

After Step S7, the processing in and after Step S5 is repeated. By the above, a possibility that the vehicle 2 is stopped outside the stop lane 110 can be reduced. On the other hand, in a case where it is determined in Step S5 that a stop position of the vehicle 2 is within the stop lane 110 (YES in Step S5), processing in and after Step S6 is performed.

In Step S6, the acquisition unit 103 acquires identification information of the vehicle 2, vehicle type information of the vehicle 2, and identification information of a provider of the vehicle 2 from the vehicle 2 stopped in the stop lane 110 of a stop stand (Step S6).

Next, the identification unit 104 acquires power receiving position information corresponding to a vehicle type indicated by the vehicle type information acquired in Step S6 from the server device 3 (Step S8).

Next, the identification unit 104 identifies a relative position of the power receiver 28 when a predetermined portion is used as a reference indicated by the power receiving position information acquired in Step S8 as an attachment position of the power receiver 28 included in the vehicle 2 stopped in the stop lane 110 of a stop stand (Step S9).

Next, the charge control unit 105 controls the moving mechanism 7 based on the stop position of the vehicle 2 detected by the detection unit 102 and the attachment position of the power receiver 28 identified in Step S9, and brings the power transmitter 8 close to the power receiver 28 included in the vehicle 2 (Step S10).

Specifically, the charge control unit 105 sets the stop position of the vehicle 2 detected by the detection unit 102 as a position of a predetermined portion serving as a reference of a relative position indicated by the attachment position of the power receiver 28 identified in Step S9. That is, the charge control unit 105 assumes that the power receiver 28 is present at a relative position indicated by the attachment position of the power receiver 28 identified in Step S9 when the stop position of the vehicle 2 detected by the detection unit 102 is used as a reference. Then, the charge control unit 105 controls the moving mechanism 7 to move a central portion 82 (FIG. 4) of the power transmission surface 80 of the power transmitter 8 to a position separated by a predetermined distance from a relative position indicated by the attachment position of the power receiver 28 identified in Step S9 when the stop position of the vehicle 2 detected by the detection unit 102 is used as a reference.

Next, the charge control unit 105 determines whether or not the power transmitter 8 is close to a position where power can be transmitted to the power receiver 28 (Step S11). Specifically, the charge control unit 105 causes a position detection circuit built in the power transmitter 8 to detect whether or not an induction coil of the power receiver 28 is at a position facing the power supply coil 81 and is within a predetermined distance from the power supply coil 81.

In a case where it is detected that an induction coil of the power receiver 28 is located at a position facing the power supply coil 81 and is located within a predetermined distance from the power supply coil 81, the charge control unit 105 determines that the power transmitter 8 is close to a position where power can be transmitted to the power receiver 28 (YES in Step S11). In this case, processing in and after Step S12 is performed.

On the other hand, in a case where it is not detected that an induction coil of the power receiver 28 is located at a position facing the power supply coil 81 and is located within a predetermined distance from the power supply coil 81, the charge control unit 105 determines that the power transmitter 8 is not close to a position where power can be transmitted to the power receiver 28 (NO in Step S11). In this case, the processing in and after Step S10 is performed again.

In Step S10 performed again, the charge control unit 105 controls the moving mechanism 7 to rotate the power transmitter 8 by a predetermined angle or move the power supply coil 81 of the power transmitter 8 in the vertical direction or the front-rear direction by a predetermined distance toward a position where power can be transmitted to the power receiver 28. The position where power can be transmitted to the power receiver 28 is a position facing an induction coil of the power receiver 28 and within a predetermined distance from the induction coil of the power receiver 28.

In Step S12, the charge control unit 105 causes the power transmitter 8 to start power transmission, and causes the current measuring device 9 to start measurement of an amount of power transmitted to the power receiver 28 by the power transmitter 8 (Step S12).

Next, every time the current measuring device 9 measures an amount of power transmitted to the power receiver 28 by the power transmitter 8 per unit time, the charge control unit 105 stores, in the memory 11, charge history information in which identification information of the power feeding stand 1, identification information of the vehicle 2 having the power receiver 28, information indicating a provider of the vehicle 2, and the measured amount of power per unit time are associated with each other (Step S13).

The charge control unit 105 determines that charging is not completed until completion of power reception by the power receiver 28 is detected (NO in Step S14), and repeats the processing in and after Step S12.

When detecting completion of power reception by the power receiver 28, the charge control unit 105 determines that the charging is completed (YES in Step S14), and transmits a charge history information group stored in the memory 11 to the server device 3 (Step S15). By the above, the wireless charging processing ends. Note that, in the server device 3, when the communication circuit 33 receives the charge history information group transmitted in Step S15, the processor 30 stores the charge history information group in the charge history information storage unit 316.

As described above, according to the configuration of the present embodiment, a stop position of the vehicle 2 is detected, and, further, an attachment position of the power receiver 28 is identified based on a vehicle type of the vehicle 2. For this reason, a position where the power receiver 28 of the stopped vehicle 2 is present can be appropriately grasped according to a vehicle type of the vehicle 2. Further, in this configuration, the power transmitter 8 can be three-dimensionally moved by the moving mechanism 7. For this reason, it is possible not only to simply move the power transmitter 8 to a position facing the power receiver 28, but also to bring the power transmitter 8 close to a position where the power receiver 28 is present. As a result, the power transmitter 8 approaching the power receiver 28 can appropriately transmit power to the power receiver 28 in a non-contact manner.

### (Variation)

A variation below can be employed for the present disclosure.

(1) In the above embodiment, the example in which each of the power feeding stands 1 includes the sensor 12 is described. However, the configuration may be such that only the power feeding stands 1 at both ends among a plurality of the power feeding stands 1 installed side by side in the charging station 4 include the sensor 12. Then, a stop position of the vehicle 2 may be detected by the detection units 102 of the power feeding stands 1 at both ends provided with the sensors 12. In this case, cost of providing the sensor 12 can be reduced.

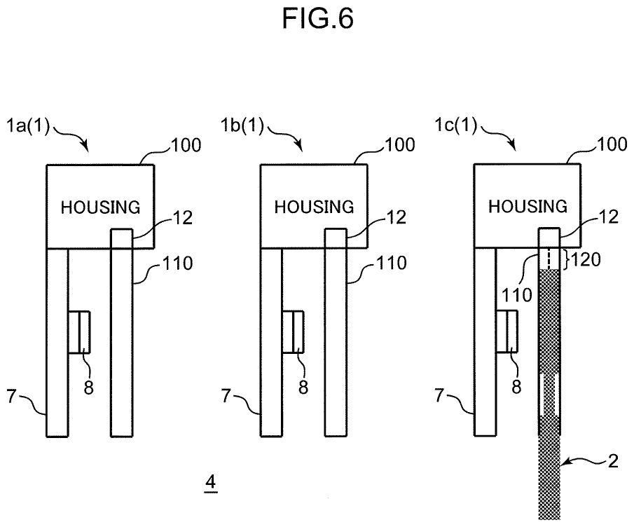

(2) In the above embodiment, the example in which the sensor 12 includes a short-range communication circuit that performs near field communication using a beacon signal. However, the sensor 12 is not limited to this, and as illustrated in FIG. 6, may include a distance measuring sensor that detects a distance 120 to an object present in the stop lane 110. The distance measuring sensor is, for example, a distance measuring sensor of an optical system using a light beam such as an infrared ray. However, the present invention is not limited to this, and the distance measuring sensor may be a distance measuring sensor of a radio wave system or a distance measuring sensor of an ultrasonic system.

In this case, the detection unit 102 may detect a stop position of the vehicle 2 based on the distance 120 detected by the sensor 12. Specifically, the detection unit 102 may detect, as a stop position of the vehicle 2, a position separated from an arrangement position of the sensor 12 by the distance 120 detected by the sensor 12 in the stop lane 110 with reference to the arrangement position of the sensor 12 stored in the memory 11.

In a case where the present variation is employed, in Step S4, the power feeding stand 1 including the detection unit 102 that detects a stop position of the vehicle 2 may be identified as a stop stand. In this case, Steps S5 and S7 (FIG. 5) can be omitted.

Note that the sensor 12 described in the above embodiment and the sensor 12 of the present variation may be provided in the power feeding stand 1, a stop position of the vehicle 2 may be detected by two methods, and an average value of these may be detected as a stop position of the vehicle 2. Here, instead of the average value, for example, the configuration may be such that only a stop position detected by a method selected by a predetermined method is used, such as that only a stop position detected by any one method selected randomly is used.

(3) The identification unit 104 may store power receiving position information acquired from the server device 3 in Step S8 (FIG. 5) in the memory 11. Alternatively, the charging station 4 may be provided with a storage device accessible from each of the power feeding stands 1, and the identification unit 104 may store power receiving position information acquired from the server device 3 in Step S8 (FIG. 5) in the storage device.

In this case, in Step S8, the identification unit 104 can acquire power receiving position information from the memory 11 or a storage device even in a case where, for example, a failure occurs in communication via the network 5 and power receiving position information cannot be acquired from the server device 3.

(4) Information indicating an address used for transmission of information to an information terminal used by the user of the vehicle 2 may be stored in the memory 21 of the vehicle 2. Then, in Step S7 (FIG. 5), similarly to Step S6 (FIG. 5), the guide unit 106 may acquire information indicating the address from the vehicle 2, and transmit information for guiding the vehicle 2 to be stopped again in the stop lane 110 to the address. Note that the information terminal includes, for example, a smartphone, a tablet terminal, an in-vehicle monitor, and the like.

In this case, it is possible to more directly guide the user to stop the vehicle 2 again in the stop lane 110 than in the above-described embodiment.

(5) In the server device 3, in every predetermined period such as once a month, the processor 30 may acquire, for each of a plurality of service providers providing the vehicle 2, a charge history information group stored in the predetermined period including identification information of each service provider from the charge history information storage unit 316, and transmit the charge history information group to a terminal used by an administrator of each service provider. Furthermore, the processor 30 may calculate electricity charge according to an amount of power with reference to a charge history information group including identification information of each service provider, and transmit the electricity charge to a terminal used by an administrator of each service provider.

Alternatively, the charge control unit 105 of each of the power feeding stands 1 may transmit a charge history information group transmitted to the server device 3 in Step S15 to a terminal used by an administrator of a service provider that provides the vehicle 2 stopped at a stop stand. Furthermore, the charge control unit 105 may calculate electricity charge corresponding to an amount of power included in the charge history information group, and transmit the electricity charge to a terminal used by an administrator of a service provider that provides the vehicle 2 stopped at a stop stand.

(6) The charging station 4 may include a control device that collectively controls the operation device 14, the speaker 15, the moving mechanism 7, the power transmitter 8, the current measuring device 9, the memory 11, the sensor 12, and the wireless communication circuit 13 included in each of the power feeding stands 1. In this case, the processor 10 provided in each of the power feeding stands 1 can be configured at low cost.

(7) The moving mechanism 7 is not limited to have the configuration illustrated in FIG. 4 in the above embodiment, and may have another configuration capable of three-dimensionally moving the power transmitter 8. Further, the housing 100 (FIG. 3) of each of the power feeding stands 4 is not limited to be installed on a floor surface of the charging station 4, and may be installed on a wall surface, a ceiling, or the like of the charging station 4. Similarly, in order to reliably bring the power transmitter 8 close to the power receiver 28 of the vehicle 2 according to a stop position and a stop posture of the vehicle 2 in the charging station 4, the moving mechanism 7 may be installed not only on a floor surface of the charging station 4 but also on a wall surface, a ceiling, or the like of the charging station 1.

(8) In the above description, an example in which a small electric vehicle on which one or two users can ride, such as an electric bicycle, an electric motorcycle, and an electric kick scooter, is employed as the vehicle 2 included in the wireless charging system 1000 is described. However, as the vehicle 2 included in the wireless charging system 1000, for example, a large rechargeable electric vehicle which three or more users can get in, such as an electric car, and a rechargeable electric autonomous vehicle may be employed. Alternatively, instead of the vehicle 2, for example, a chargeable electric moving body such as an electric robot and a drone may be employed.

(9) In the present disclosure, the above embodiment and variations (1) to (8) may be optionally combined.

According to the present disclosure, it is possible to appropriately bring a power transmitter close to a power receiver according to a type of an electric moving body and to appropriately transmit power to the power receiver in a non-contact manner. For this reason, the present disclosure is useful for charging each vehicle in a sharing service that allows a plurality of types of electric moving bodies to be shared.

1. A wireless charging device comprising:
a power transmitter that wirelessly transmits power to a power receiver included in an electric moving body;
a moving mechanism that moves the power transmitter;
a detection unit that detects a stop position of the moving body;
an acquisition unit that acquires information indicating a type of the moving body;
an identification unit that identifies an attachment position of the power receiver based on the type; and
a charge control unit that controls the moving mechanism based on the stop position and the attachment position to bring the power transmitter close to the power receiver.

2. The wireless charging device according to claim 1, wherein the identification unit acquires power receiving position information in which the type is associated with a relative position of the power receiver when a predetermined portion of the moving body of the type is used as a reference, and identifies the relative position associated with the type in the power receiving position information as the attachment position.

3. The wireless charging device according to claim 2, wherein the charge control unit sets the stop position as a position of the predetermined portion of the moving body being stopped, and moves the power transmitter to a position separated by a predetermined distance from the relative position indicated by the attachment position when the stop position is used as a reference.

4. The wireless charging device according to claim 3, further comprising a sensor that transmits a beacon signal and detects a direction from a position where the beacon signal is transmitted to a position where the beacon signal is received, the wireless charging device being installed side by side with other one or more wireless charging devices having a same configuration as that of the wireless charging device,
wherein the moving body includes a receiving circuit that receives the beacon signal, and
the detection unit detects the stop position based on the direction detected by the sensor and by the sensor included in one of the other one or more wireless charging devices.

5. The wireless charging device according to claim 3, further comprising a distance measuring sensor that detects a distance to an object present in a predetermined stop area,
wherein the detection unit detects the stop position based on the distance detected by the distance measuring sensor.

6. The wireless charging device according to claim 1, wherein the moving mechanism is configured to be capable of moving the power transmitter along a first direction parallel to a ground on which the moving mechanism is installed and a power transmission surface of power of the power transmitter, a second direction orthogonal to the ground, and a third direction orthogonal to the first direction and the second direction.

7. The wireless charging device according to claim 6, wherein the moving mechanism is further configured to be capable of rotating the power transmitter about a first axis parallel to the first direction and a second axis parallel to the second direction.

8. The wireless charging device according to claim 1, further comprising a guide unit that determines whether or not the stop position is within a predetermined stop area, and guides the moving body to be stopped again within the stop area in a case where the stop position is outside the stop area.

9. The wireless charging device according to claim 1, wherein the charge control unit determines whether or not the power transmitter is close to a position where power transmission to the power receiver is allowed, and rotates the power transmitter by a predetermined angle or moves the power transmitter by a predetermined distance toward the position where the power transmission is allowed until determining that the power transmitter is close to the position where the power transmission is allowed.

10. The wireless charging device according to claim 1, further comprising an authentication unit that acquires a token of the moving body and authenticates whether or not the token is issued by a provider of the moving body,
wherein the detection unit, the acquisition unit, the identification unit, and the charge control unit operate in a case where the token is authenticated to be issued by the provider.

11. The wireless charging device according to claim 10, further comprising a measurement unit that measures an amount of power transmitted from the power transmitter to the power receiver,
wherein the charge control unit further outputs, in a case where completion of power reception of power by the power receiver is detected, information in which identification information of the wireless charging device, identification information of the provider, identification information of the moving body, and information on the amount of power measured by the measurement unit from start to completion of power transmission of the power are associated with each other.

12. A wireless charging method in a wireless charging device including a power transmitter that wirelessly transmits power to a power receiver included in an electric moving body, and a moving mechanism that moves the power transmitter, the method comprising:
by a computer of the wireless charging device,
detecting a stop position of the moving body;
acquiring information indicating a type of the moving body;
identifying an attachment position of the power receiver based on the type; and
controlling the moving mechanism based on the stop position and the attachment position to bring the power transmitter close to the power receiver.

13. A non-transitory computer readable storage medium storing a program that causes a computer of a wireless charging device including a power transmitter that wirelessly transmits power to a power receiver included in an electric moving body and a moving mechanism that moves the power transmitter to function as:
a detection unit that detects a stop position of the moving body;
an acquisition unit that acquires information indicating a type of the moving body;
an identification unit that identifies an attachment position of the power receiver based on the type; and
a charge control unit that controls the moving mechanism based on the stop position and the attachment position to bring the power transmitter close to the power receiver.
